(19) United States
(12) Patent Application Publication
(10) Pub. No.: US 2017/0117007 A1
(43) Pub. Date: Apr. 27, 2017

(54) TRANSMISSION DEVICE AND TRANSMISSION METHOD FOR TRANSMITTING SOUND SIGNAL

(71) Applicant: JVC KENWOOD Corporation, Yokohama-shi (JP)

(72) Inventor: Hiroshi FURUTA, Yokohama-shi (JP)

(73) Assignee: JVC KENWOOD Corporation, Yokohama-shi (JP)

(21) Appl. No.: 15/297,607

(22) Filed: Oct. 19, 2016

(30) Foreign Application Priority Data
Oct. 23, 2015 (JP) 2015-208628

(51) Int. Cl. G10L 25/87; G10L 15/00

(52) U.S. Cl. CPC G10L 25/87; G10L 15/005; G10L 2025/783

(57) ABSTRACT

An inputter inputs a sound signal. A delayer delays the input sound signal. An acceptor accepts a command to transmit the sound signal. A transmitter transmits the sound signal delayed in the delayer when a level of the sound signal delayed in the delayer is larger than or equal to a threshold value when the acceptor accepts the command. On the other hand, the transmitter transmits the sound signal input from the inputter when the level of the sound signal delayed in the delayer is smaller than the threshold value.

### CROSS-REFERENCE TO RELATED APPLICATION

This application is based upon and claims the benefit of priority from the prior Japanese Patent Application No. 2015-208628, filed on Oct. 23, 2015, the entire contents of which are incorporated herein by reference.

### BACKGROUND

1. Field

The present invention relates to transmission technique. The present invention specifically relates to a transmission device and a transmission method for transmitting a sound signal.

2. Description of the Related Art

Terminal devices compatible with “push to talk” (PTT) include a special button. A user speaks while pressing the button. Meanwhile, when the button is not pressed, the user only hears a message. With such a terminal device, the user often starts speaking while pressing the button. In this case, a message with truncated sound in the first one to two seconds is transmitted. In order to prevent the sound in the first one to two seconds from being truncated, sound before pressing the button is stored. When the button is pressed, a message is transmitted from the stored sound (for example, JP 2007-335968 A).

Patent Literature 1: JP 2007-335968 A

When a button is pressed by a user and a message is transmitted from stored sound, transmission of sound is usually delayed. However, it is preferable that transmission of sound is not delayed.

### SUMMARY

In order to solve the above problem, a transmission device of one aspect of the present embodiment includes an inputter that inputs a sound signal, a delayer that delays the sound signal input by the inputter, an acceptor that accepts a command to transmit the sound signal, and a transmitter that transmits the sound signal delayed in the delayer when a level of the sound signal delayed in the delayer is larger than or equal to a threshold value and transmits the sound signal input from the inputter when the level of the sound signal delayed in the delayer is smaller than the threshold value when the acceptor accepts the command.

Another aspect of the present embodiment is also a transmission device. This device includes an inputter that inputs a sound signal, a delayer that delays the sound signal input by the inputter, an acceptor that accepts a command to transmit the sound signal, a determiner that determines whether the sound signal delayed in the delayer is in a first language or a second language different from the first language when the acceptor accepts the command, and a transmitter that transmits the sound signal delayed in the delayer when the determiner determines the sound signal as in the first language and transmits the sound signal input by the inputter when the determiner determines the sound signal as in the second language.

Still another aspect of the present embodiment is a transmission method. This method includes a step of inputting a sound signal, a step of delaying the input sound signal, a step of accepting a command to transmit the sound signal, and a step of transmitting the delayed sound signal when a level of the delayed sound signal is larger than or equal to a threshold value and transmitting the input sound signal when the level of the delayed sound signal is smaller than the threshold value when the command is accepted.

Yet another aspect of the present embodiment is also a transmission method. This method includes a step of inputting a sound signal, a step of delaying the input sound signal, a step of accepting a command to transmit the sound signal, and a step of determining whether the delayed sound signal is in a first language or a second language different from the first language when the command is accepted, and a step of transmitting the delayed sound signal when the sound signal is determined as in the first language and transmitting the input sound signal when the sound signal is determined as in the second language.

Incidentally, an arbitrary combination of the above components as well as those where representation of the present embodiment is converted among a method, a device, a system, a recording medium, a computer program, or the like are also valid as an aspect of the present embodiment.

### BRIEF DESCRIPTION OF THE DRAWINGS

FIG. 1 is a diagram illustrating a configuration of a communication system according to example 1;

FIG. 2 is a diagram illustrating a configuration of a transmission device in a terminal device in FIG. 1;

FIG. 3 is a flowchart illustrating a transmission procedure by the transmission device in FIG. 2;

FIG. 4 is a diagram illustrating a configuration of a transmission device according to example 2;

FIG. 5 is a flowchart illustrating a transmission procedure by the transmission device in FIG. 4;

FIG. 6 is a diagram illustrating a configuration of a transmission device according to example 3; and

FIG. 7 is a flowchart illustrating a transmission procedure by the transmission device in FIG. 6.

### DETAILED DESCRIPTION

The invention will now be described by reference to the preferred embodiments. This does not intend to limit the scope of the present invention, but to exemplify the invention.

### Example 1

Before specifically describing the present invention, an overview will be first described. Example 1 relates to, of terminal devices that execute sound communication by PTT, a transmission device that transmits a message of sound. Transmission by PTT is initiated by pressing a button and terminated by releasing the button. When a terminal device is used in a tense situation, a user often speaks in a hurry while pressing the button. When speech is made earlier than pressing the button, sound uttered before pressing the button is not transmitted and thus the first sound is truncated. However, it is preferable that truncation of the first sound is suppressed. Meanwhile in sound communication such as PTT, it is preferable that delay in transmission of sound is small. In order to cope with this, the transmission device according to the present example executes the following processing.

The transmission device stores, in a memory, a sound signal input from a microphone before pressing the button. When the button is pressed, the transmission device measures a level of the sound signal stored in the memory. When the measured level is larger than or equal to a threshold value, the transmission device initiates transmission from the sound signal stored in the memory. On the other hand, when the measured level is smaller than the threshold value, the transmission device does not use the sound signal stored in the memory and initiates transmission from the sound signal input from the microphone.

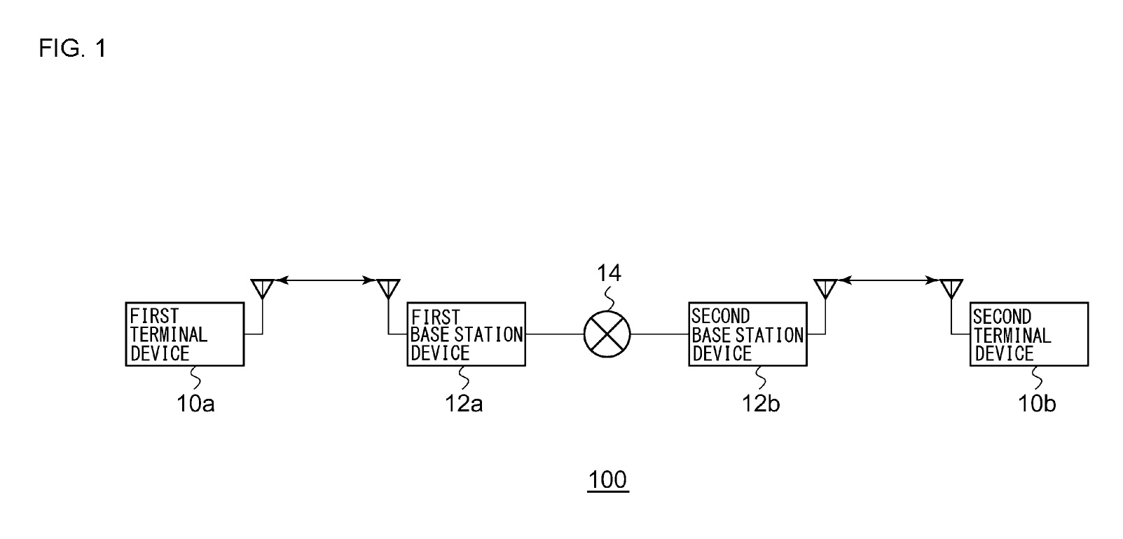

FIG. 1 is a diagram illustrating a configuration of a communication system 100 according to example 1. The communication system 100 includes a first terminal device 10a and a second terminal device 10b collectively referred to as terminal devices 10, a first base station device 12a and a second base station device 12b collectively referred to as base station devices 12, and a network 14. Here, the communication system 100 corresponds to business-use radio for example.

The terminal device 10 can execute communication by business-use radio. As for business-use radio, it is only required to use known technique and thus descriptions are omitted here. Here, the first terminal device 10a corresponds to a transmitting side of sound communication by business-use radio and the second terminal device 10b corresponds to a receiving side of sound communication by business-use radio. Therefore, the first terminal device 10a is used by a speaker while the second terminal device 10b is used by a listener. Incidentally, relation between the first terminal device 10a and the second terminal device 10b may be vice versa. The number of the terminal devices 10 is not limited to two.

The base station device 12 is compatible with a system of business-use radio. The base station device 12 is connected to the terminal device 10 by business-use radio at one end thereof while connected to the base station device 12 at the other end thereof. The first base station device 12a and the second base station device 12b are disposed at different locations. Incidentally, in business-use radio, a group may be formed by a plurality of terminal devices 10. The base station device 12 may allot an uplink channel and a downlink channel to the group. In such circumstances, one of the terminal devices 10 in the group transmits a signal in the uplink channel and another terminal device 10 in the group receives a signal in the downlink channel.

The network 14 connects the first base station device 12a and the second base station device 12b. With such connection, the first terminal device 10a and the second terminal device 10b are allowed to communicate with each other via the first base station device 12a, the network 14, and the second base station device 12b. Here, sound communication by PTT is assumed.

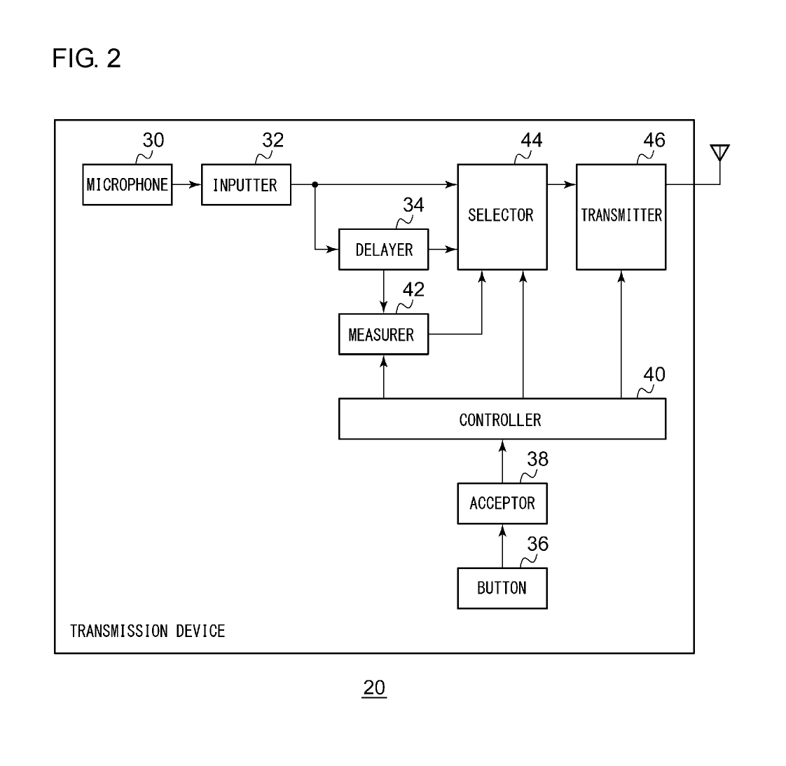

FIG. 2 is a diagram illustrating a configuration of a transmission device 20 in the terminal device 10. The transmission device 20 includes a microphone 30, an inputter 32, a delayer 34, a button 36, an acceptor 38, a controller 40, a measurer 42, a selector 44, and a transmitter 46. Here, the transmission device 20 corresponds to a part of the terminal device 10, the part having a function related to transmission of a sound signal. Therefore, the terminal device 10 includes not only the transmission device 20 but also a receiving device that is a part having a function related to reception of a sound signal. However, descriptions are omitted here.

The microphone 30 collects sound surrounding the transmission device 20. The microphone 30 converts the collected sound into an electric signal (hereinafter referred to as “sound signal”) and outputs the sound signal to the inputter 32. The inputter 32 inputs the sound signal from the microphone 30. The inputter 32 converts the sound signal from an analog signal into a digital signal and outputs, to the delayer 34 and the selector 44, the sound signal converted into a digital signal (hereinafter also referred to as “sound signal”). The delayer 34 inputs the sound signal from the inputter 32. The delayer 34 includes a ring buffer or the like for example and stores the sound signal for a certain period of time. This allows the delayer 34 to delay the sound signal. The delayer 34 outputs the delayed sound signal to the selector 44.

The button 36 corresponds to a PTT button and is pressed by a user when sound is transmitted by PTT. Furthermore, the button 36 is kept pressed for the entire time while sound is transmitted. Pressing the button 36 corresponds to accepting a command to transmit a sound signal. The button 36 continues to output the command to the acceptor 38 for the entire time while being pressed. The acceptor 38, upon accepting the command from the button 36, outputs the command to the controller 40.

The controller 40 commands the measurer 42 to measure a level of a sound signal upon accepting the command from the acceptor 38. The controller 40 further continues to command the selector 44 and the transmitter 46 to perform transmission for the entire time while accepting the command from the acceptor 38. The measurer 42 measures the level of the sound signal delayed in the delayer 34 upon commanded by the controller 40 to perform measurement. As for the measurement, it is only required to use known technique and thus descriptions are omitted here. The measurer 42 outputs a measurement result to the selector 44.

The selector 44 inputs the measurement result from the measurer 42 upon initiation of input of the command from the controller 40. Meanwhile, the selector 44 stores a threshold value to be compared to the level of the sound signal in the measurement result. The selector 44 determines to select the sound signal from the delayer 34 when the level of the sound signal is larger than or equal to the threshold value and determines to select the sound signal from the inputter 32 when the level of the sound signal is smaller than the threshold value. The former corresponds to selecting the sound signal delayed in the delayer 34 and the latter corresponds to selecting the sound signal not delayed in the delayer 34.

The selector 44 further continues to input the sound signal from the delayer 34 and the sound signal from the inputter 32. The selector 44 selects one of the above according to determination and outputs the selected sound signal to the transmitter 46. The selector 44 continues to select and output for the entire time while the command from the controller 40 is input. Moreover, even when input of the command from the controller 40 is terminated, the selector 44 continues to select and output for a certain period of time. This is to suppress truncation of the end of sound when timing of the user to release the button 36 is earlier than timing of terminating the speech. Therefore, the certain period of time is set to a period of time that allows for suppressing truncation of the end of the sound. Incidentally, while the sound signal from the delayer 34 is selected, the selector 44 prolongs selecting and outputting by a delayed period of time in the delayer 34.

The transmitter 46 transmits the sound signal input from the selector 44 upon input of the command from the controller 40. For transmission of a sound signal, the transmitter 46 executes coding, modulation, frequency conversion, amplification, etc. The transmitter 46 continues to execute transmission of a sound signal for the entire time while the sound signal from the selector 44 is input. In this manner, the transmitter 46 transmits the sound signal delayed in the delayer 34 when a level of the sound signal delayed in the delayer 34 is larger than or equal to the threshold value when the acceptor 38 accepts the command. On the other hand, the transmitter 46 transmits the sound signal input from the inputter 32 without delay when the level of the sound signal delayed in the delayer 34 is smaller than the threshold value.

This configuration can be implemented by a CPU, a memory, or other LSI of any computer from the perspectives of hardware and, from the perspectives of software, by a program or the like loaded to a memory. Here, functional blocks implemented by coordination thereof are illustrated. Therefore, it should be understood by a person skilled in the art that these functional blocks can be implemented by various forms including hardware only, software only, or a combination thereof.

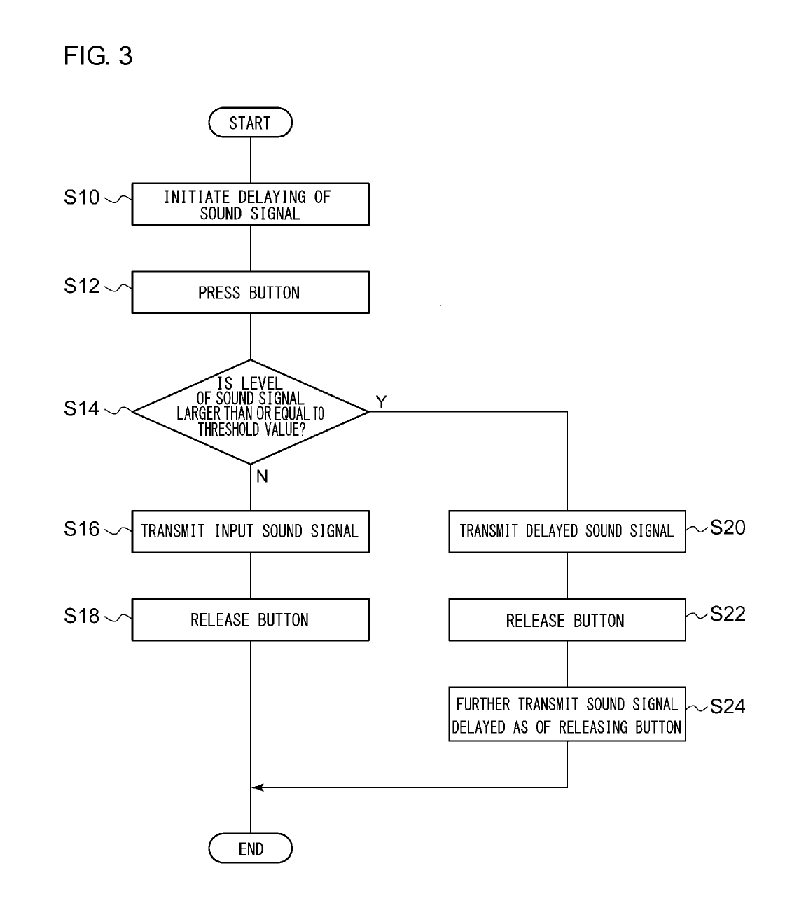

Operations of the communication system 100 with the above configuration will be described. FIG. 3 is a flowchart illustrating a transmission procedure by the transmission device 20. The delayer 34 initiates delaying of the sound signal (S10). The button 36 is pressed (S12). When the level of the sound signal is not larger than or equal to the threshold value (N in S14), the selector 44 causes the transmitter 46 to transmit the sound signal input from the inputter 32 (S16). The button 36 is released (S18). When the level of the sound signal is larger than or equal to the threshold value (Y in S14), the selector 44 causes the transmitter 46 to transmit the sound signal delayed in the delayer 34 (S20). The button 36 is released (S22). The transmitter 46 also transmits the sound signal delayed as of releasing the button 36 (S24).

According to the present example, the delayed sound signal is transmitted when the level of the delayed sound signal is larger than or equal to the threshold value and thus truncation of the first sound in PTT can be suppressed. Furthermore, the input sound signal is transmitted without delay when the level of the delayed sound signal is smaller than the threshold value and thus delay in transmission of sound can be suppressed. Moreover, since whether to delay the sound is determined according to the level of the sound signal, delay in transmission of sound can be suppressed while truncation of the first sound in PTT is suppressed.

### Example 2

Next, example 2 will be described. Like example 1, example 2 relates to, of terminal devices that execute sound communication by PTT, a transmission device that transmits a message of sound. As described above, in sound communication of PTT, it is preferable that truncation of the first sound is suppressed. Meanwhile, it is also preferable that delay upon transmission of sound is also suppressed. Here, when a language in the sound communication is English, a meaning of a sentence maybe significantly different due to truncation of the first sound. For example in police radio, when original utterance of “Don't shoot” is truncated of the first sound and thus turns to “Shoot,” which means the contrary. Meanwhile when a language in sound communication is Japanese, even when the first sound is truncated, meaning of a sentence is unlikely to be the contrary. That is, influence of truncation of the first sound is significantly different depending on whether the language includes a term for distinguishing between affirmative sentences and negative sentences in a front part of a sentence. In order to cope with this, the transmission device according to the present example executes the following processing.

The transmission device stores, in a memory, a sound signal input from a microphone before pressing the button. When the button is pressed, the transmission device determines a language of a sound signal stored in a memory. When the language is English, the transmission device initiates transmission of a message from the sound signal stored in the memory. On the other hand, when the language is Japanese, the transmission device does not use the sound signal stored in the memory and initiates transmission of a message from the sound signal input from the microphone. A communication system according to example 2 is of a similar type to that in FIG. 1. Here, differences from the above will be mainly described.

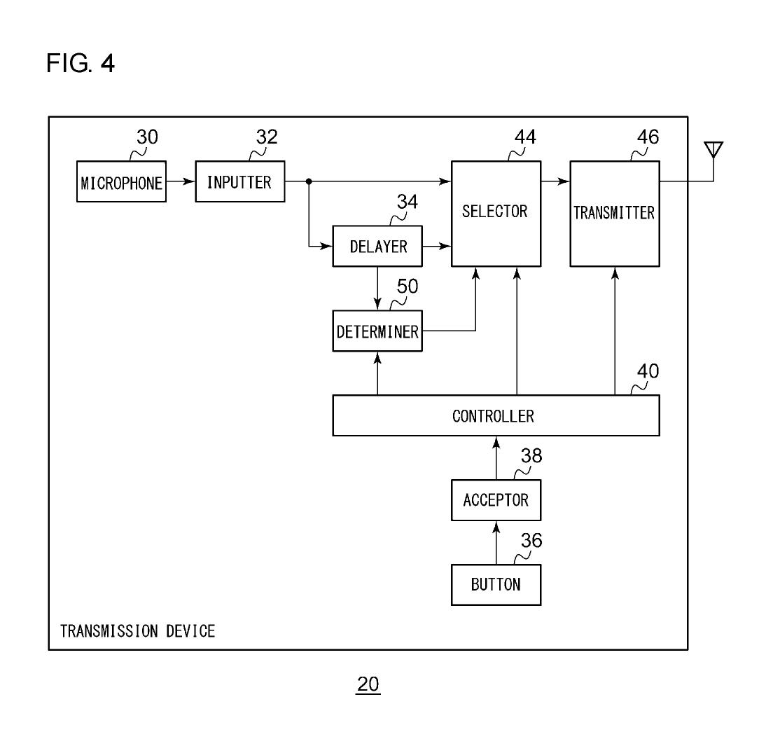

FIG. 4 is a diagram illustrating a configuration of a transmission device 20 according to example 2. The transmission device 20 includes a microphone 30, an inputter 32, a delayer 34, a button 36, an acceptor 38, a controller 40, a selector 44, a transmitter 46, and a determiner 50. Like in FIG. 2, the transmission device 20 corresponds to a part of the terminal device 10, the part having a function related to transmission of a sound signal. Therefore, the terminal device 10 includes not only the transmission device 20 but also a receiving device that is a part having a function related to reception of a sound signal. However, descriptions are omitted here.

The controller 40 commands the determiner 50 to determine a language of the sound signal upon accepting a command from the acceptor 38. The controller 40 further continues to command the selector 44 and the transmitter 46 to perform transmission for the entire time while accepting the command from the acceptor 38. When commanded to determine a language by the controller 40, the determiner 50 determines whether the sound signal delayed in the delayer 34 is in a first language or a second language different from the first language. Here, the first language is a language including a term for distinguishing between affirmative sentences and negative sentences in a front part of a sentence, such as English. Also, the second language is a language including a term for distinguishing between affirmative sentences and negative sentences in a rear part of a sentence, such as Japanese. Incidentally, the first language is not limited to English and the second language is not limited to Japanese. As for determination of the language, it is only required to use known technique and thus descriptions are omitted here. The determiner 50 outputs a determination result to the selector 44.

The selector 44 inputs the determination result from the determiner 50 upon initiation of input of the command from the controller 40. The selector 44 determines to select the sound signal delayed in the delayer 34 when the determiner 50 determines the sound signal as in the first language and determines to select the sound signal input from the inputter 32 when the determiner 50 determines the sound signal as in the second language. The former corresponds to selecting the sound signal delayed in the delayer 34 and the latter corresponds to selecting the sound signal not delayed in the delayer 34. The selector 44 further continues to input the sound signal from the delayer 34 and the sound signal from the inputter 32. The selector 44 selects one of the above according to determination and outputs the selected sound signal to the transmitter 46. The transmitter 46 transmits the sound signal input from the selector 44 upon input of the command from the controller 40.

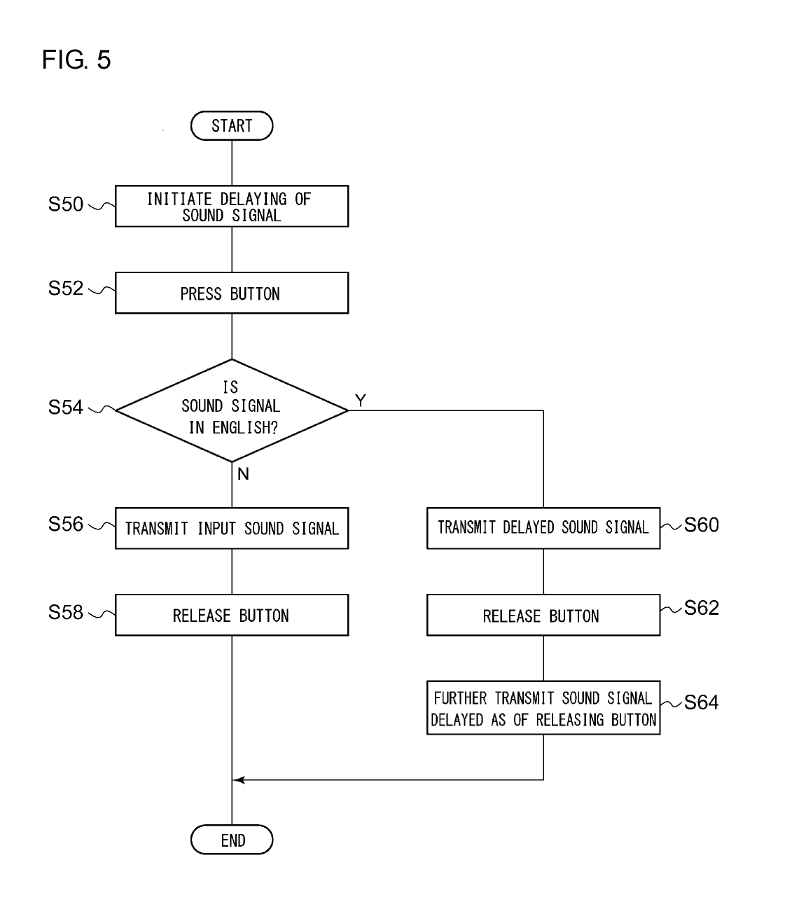

Operations of the communication system 100 with the above configuration will be described. FIG. 5 is a flowchart illustrating a transmission procedure by the transmission device 20. The delayer 34 initiates delaying of the sound signal (S50). The button 36 is pressed (S52). When the sound signal is not in English (N in S54), the selector 44 causes the transmitter 46 to transmit the sound signal input from the inputter 32 (S56). The button 36 is released (S58). When the sound signal is in English (Y in S54), the selector 44 causes the transmitter 46 to transmit the sound signal delayed in the delayer 34 (S60). The button 36 is released (S62). The transmitter 46 also transmits the sound signal delayed as of releasing the button 36 (S64).

According to the present example, the delayed sound signal is transmitted when the delayed sound signal is determined as in the first language and thus truncation of the first sound in PTT can be suppressed. Furthermore, the input sound signal is transmitted without delay when the delayed sound signal is determined as in the second language and thus delay in transmission of sound can be suppressed. Furthermore in the first language, a term for distinguishing between affirmative sentences and negative sentences is disposed in a front part of a sentence and thus suppressing truncation of the first sound allows for correctly conveying the meaning. Furthermore in the second language, a term for distinguishing between affirmative sentences and negative sentences is disposed in a rear part of a sentence and thus suppressing delay allows for promptly conveying the meaning.

### Example 3

Next, example 3 will be described. Like the above examples including example 1, example 3 relates to, of terminal devices that execute sound communication by PTT, a transmission device that transmits a message of sound. As described above, in sound communication of PTT, it is preferable that truncation of the first sound is suppressed. Meanwhile, it is also preferable that delay upon transmission of sound is also suppressed. Example 3 corresponds to a combination of example 1 and example 2.

That is, when a button is pressed, a transmission device according to example 3 measures a level of a sound signal stored in a memory while determines a language of the sound signal stored in the memory. When the measured level is larger than or equal to a threshold value and the language is English, the transmission device initiates transmission of a message from the sound signal stored in the memory. On the other hand, when the measured level is larger than or equal to the threshold value and the language is Japanese, or when the measured level is smaller than the threshold value, the transmission device does not use the sound signal stored in the memory and initiates transmission of a message from the sound signal input from the microphone. A communication system according to example 3 is of a similar type to that in FIG. 1. Here, differences from the above will be mainly described.

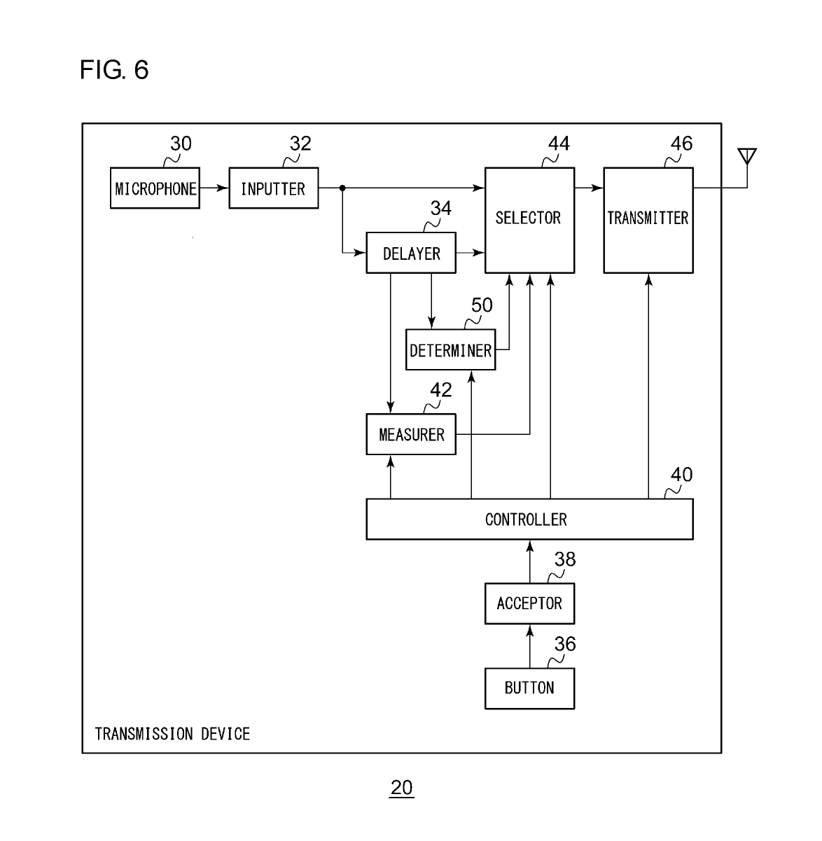

FIG. 6 is a diagram illustrating a configuration of a transmission device 20 according to example 3. The transmission device 20 includes a microphone 30, an inputter 32, a delayer 34, a button 36, an acceptor 38, a controller 40, a measurer 42, a selector 44, a transmitter 46, and a determiner 50. Like in the above, the transmission device 20 corresponds to a part of the terminal device 10, the part having a function related to transmission of a sound signal. Therefore, the terminal device 10 includes not only the transmission device 20 but also a receiving device that is a part having a function related to reception of a sound signal. However, descriptions are omitted here.

The controller 40 commands the measurer 42 to measure the level of a sound signal and the determiner 50 to determine a language of the sound signal upon accepting a command from the acceptor 38. The controller 40 further continues to command the selector 44 and the transmitter 46 to perform transmission for the entire time while accepting the command from the acceptor 38. The measurer 42 measures the level of the sound signal delayed in the delayer 34 and outputs the measurement result to the selector 44 upon commanded by the controller 40 to perform measurement. When commanded to determine a language by the controller 40, the determiner 50 determines whether the sound signal delayed in the delayer 34 is in the first language or the second language different from the first language and outputs the determination result to the selector 44.

The selector 44 inputs the measurement result from the measurer 42 and the determination result from the determiner 50 upon initiation of input of the command from the controller 40. Meanwhile, the selector 44 stores a threshold value to be compared to the level of the sound signal in the measurement result. The selector 44 determines to select the sound signal from the inputter 32 when the level of the sound signal is smaller than the threshold value. The selector 44 determines to select the sound signal delayed in the delayer 34 when the determiner 50 determines the sound signal as in the first language when the level of the sound signal is larger than or equal to the threshold value. The selector 44 determines to select the sound signal input from the inputter 32 when the determiner 50 determines the sound signal as in the second language when the level of the sound signal is larger than or equal to the threshold value. The selector 44 further continues to input the sound signal from the delayer 34 and the sound signal from the inputter 32. The selector 44 selects one of the above according to determination and outputs the selected sound signal to the transmitter 46.

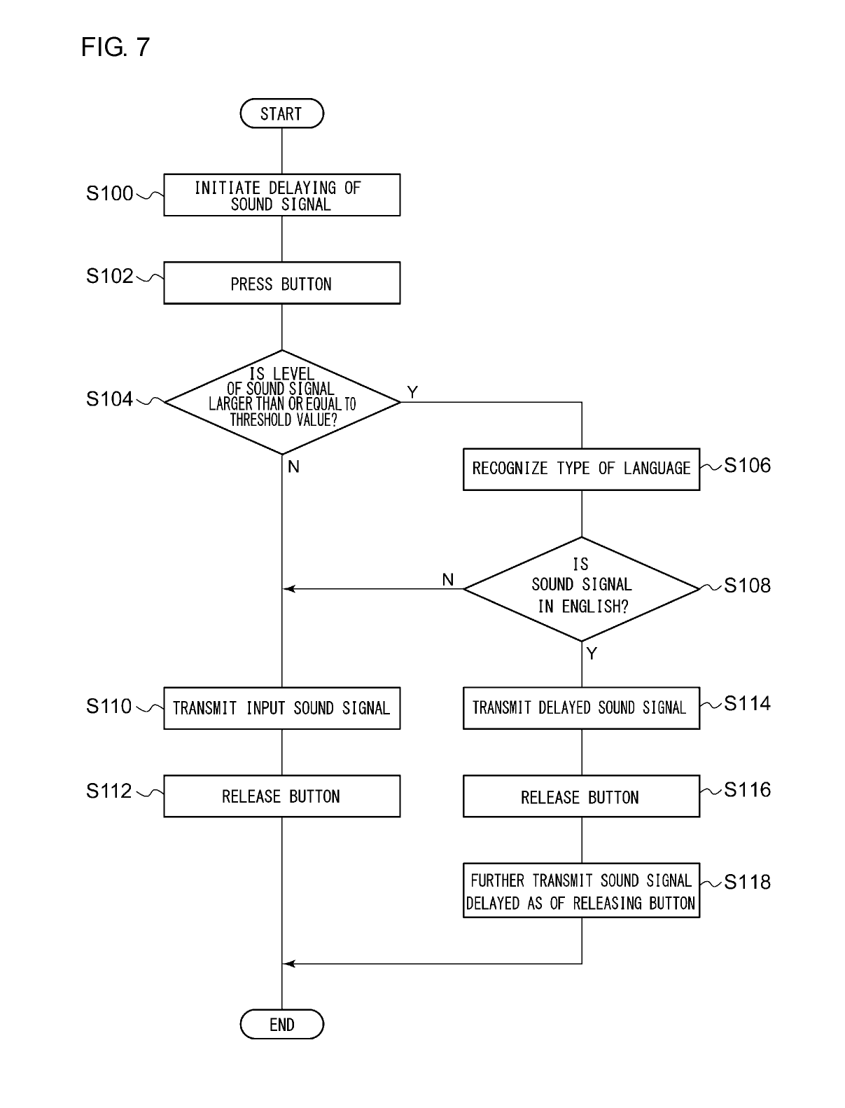

Operations of the communication system 100 with the above configuration will be described. FIG. 7 is a flowchart illustrating a transmission procedure by the transmission device 20. The delayer 34 initiates delaying of the sound signal (S100). The button 36 is pressed (S102). When the level of the sound signal is not larger than or equal to the threshold value (N in S104), the selector 44 causes the transmitter 46 to transmit the sound signal input from the inputter 32 (S110). The button 36 is released (S112). When the level of the sound signal is larger than or equal to the threshold value (Y in S104), the determiner 50 recognizes a type of a language (S106). When the sound signal is not in English (N in S108), the flow proceeds to step 5110. When the sound signal is in English (Y in S108), the selector 44 causes the transmitter 46 to transmit the sound signal delayed in the delayer 34 (S114). The button 36 is released (S116). The transmitter 46 also transmits the sound signal delayed as of releasing the button 36 (S118).

According to the present example, whether to delay is determined by combination of the level and a language and thus a sound signal can be delayed only in limited necessary cases. Moreover, since a sound signal is delayed only in limited necessary cases, truncation of the first sound can be suppressed only in cases where there is a high possibility that truncation of the first sound results in conveying incorrect meaning. Furthermore, since a sound signal is delayed only in limited necessary cases, delay in a sound signal can be suppressed.

The present invention has been described above based on the examples. These examples are merely illustration. Therefore, it should be understood by a person skilled in the art that combinations of the components or processing processes of the examples may include various variations and that such a variation is also within the scope of the present invention.

In the present example, the communication system 100 uses business-use radio. However, the radio is not limited thereto and, for example, a wireless communication system other than business-use radio maybe used. The present example allows for enhancing flexibility of configuration.

What is claimed is:

1. A transmission device, comprising:
an inputter that inputs a sound signal;
a delayer that delays the sound signal input by the inputter;
an acceptor that accepts a command to transmit the sound signal; and
a transmitter that transmits the sound signal delayed in the delayer when a level of the sound signal delayed in the delayer is larger than or equal to a threshold value and transmits the sound signal input by the inputter when the level of the sound signal delayed in the delayer is smaller than the threshold value when the acceptor accepts the command.

2. The transmission device according to claim 1, further comprising:
a determiner that determines whether the sound signal delayed in the delayer is in a first language or a second language different from the first language when the acceptor accepts the command,
wherein the transmitter (1) transmits the sound signal delayed in the delayer when the determiner determines the sound signal as in the first language and (2) transmits the sound signal input by the inputter when the determiner determines the sound signal as in the second language, when the acceptor accepts the command and the level of the sound signal delayed in the delayer is larger than or equal to the threshold value.

3. A transmission device, comprising:
an inputter that inputs a sound signal;
a delayer that delays the sound signal input by the inputter;
an acceptor that accepts a command to transmit the sound signal;
a determiner that determines whether the sound signal delayed in the delayer is in a first language or a second language different from the first language when the acceptor accepts the command; and
a transmitter that transmits the sound signal delayed in the delayer when the determiner determines the sound signal as in the first language and transmits the sound signal input by the inputter when the determiner determines the sound signal as in the second language.

4. The transmission device according to claim 2,
wherein the first language is a language that includes a term for distinguishing between affirmative sentences and negative sentences in a front part of a sentence and the second language is a language that includes a term for distinguishing between affirmative sentences and negative sentences in a rear part of a sentence.

5. The transmission device according to claim 3,
wherein the first language is a language that includes a term for distinguishing between affirmative sentences and negative sentences in a front part of a sentence and the second language is a language that includes a term for distinguishing between affirmative sentences and negative sentences in a rear part of a sentence.

6. A transmission method, comprising:
a step of inputting a sound signal;
a step of delaying the input sound signal;
a step of accepting a command to transmit the sound signal; and
a step of transmitting the delayed sound signal when a level of the delayed sound signal is larger than or equal to a threshold value and transmitting the input sound signal when the level of the delayed sound signal is smaller than the threshold value when the command is accepted.
